(19) United States
(12) Patent Application Publication
(10) Pub. No.: US 2007/0031261 A1
(43) Pub. Date: Feb. 8, 2007

(54) Turbine having variable throat

(76) Inventors: Alain Lombard, Uxgeney (FR); Denis Tisserant, Thaon-les-Vosges (FR); Stephane D'Hauenens, Thaon-les-Vosges (FR)

Correspondence Address: HONEYWELL TURBO TECHNOLOGIES, 23326 HAWTHORNE BOULEVARD, SUITE #200, TORRANCE, CA, 90505, US

(21) Appl. No.: 10/546,384

(22) PCT Filed: Feb. 19, 2003
(86) PCT No.: PCT/IB03/00576

§ 371 Date: Sep. 22, 2006

(51) Int. Cl. B64C 11/16

(52) U.S. Cl. 416/203

(57) ABSTRACT

The invention relates to a turbine (1) for a turbocharger, comprising a turbine wheel (2) and a turbine housing (5) forming a passage (6) for guiding a fluid flow to the turbine wheel (2), said passage (6) comprising a variable throat providing a throat area (8) as a smallest cross section of the fluid flow, wherein the variable throat is always defined by a annular member (7) surrounding the turbine wheel (2) and being movable in the axial direction of the turbine wheel (2).

The present invention generally relates to a turbine for use in a turbocharger, and in particular a turbine having a variable throat for use in a turbocharger.

A conventional turbine of a turbocharger is disclosed in JP-A-60-006020. The turbine comprises a turbine wheel and a turbine housing forming a passage for guiding a fluid flow to the turbine wheel. Within the passage of the turbine housing, a flap is pivotally arranged so as to adjust a smallest cross section of the fluid flow. The smallest cross section of the fluid flow is also called a throat area. An additional actuator is required for pivoting the flap.

It is the object of the present invention to provide a turbine having an improved efficiency and a simplified construction.

This object is achieved by a turbine having the features of claim 1. The invention is further developed as it is defined in the dependent claims.

According to a first aspect of the present invention, a turbine for a turbocharger comprises a turbine wheel and a turbine housing forming a passage for guiding a fluid flow to the turbine wheel, said passage comprising a variable throat for adjusting a throat area of the fluid flow, wherein the variable throat is a annular member surrounding the turbine wheel and being movable in the axial direction of the turbine wheel.

According to a second aspect of the invention, the turbine wheel comprises turbine blades extending the axial direction of the turbine wheel with different lengths.

Preferably, the turbine wheel comprises a plurality of first turbine blades having a first length associated with a first throat area, and a plurality of second turbine blades having a second length associated with a second throat area, wherein the first length being different from the second length.

Preferably, the first and second turbine blades are alternately arranged in the circumferential direction of the turbine wheel.

Preferably, the turbine further comprises a nozzle disposed within the passage, said nozzle comprising stationary or movable vanes.

Preferably, the annular member is moved in accordance to an operational state of the turbocharger.

Preferably, the throat area increases if a rotational speed of the turbocharger increases.

Other objects and features of the present invention are obvious from the following description of the figures.

Preferred embodiments of the present invention are explained in detail under reference of the figures.

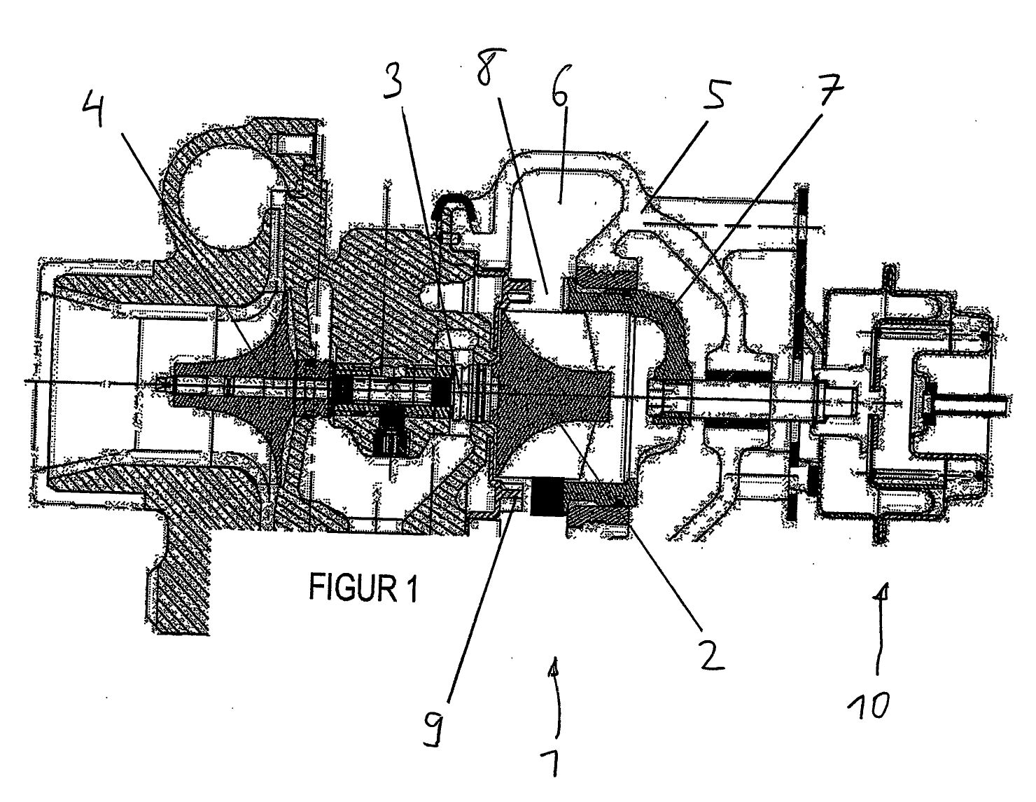

FIG. 1 shows a turbine at high rotational speed according to a first embodiment of the present invention;

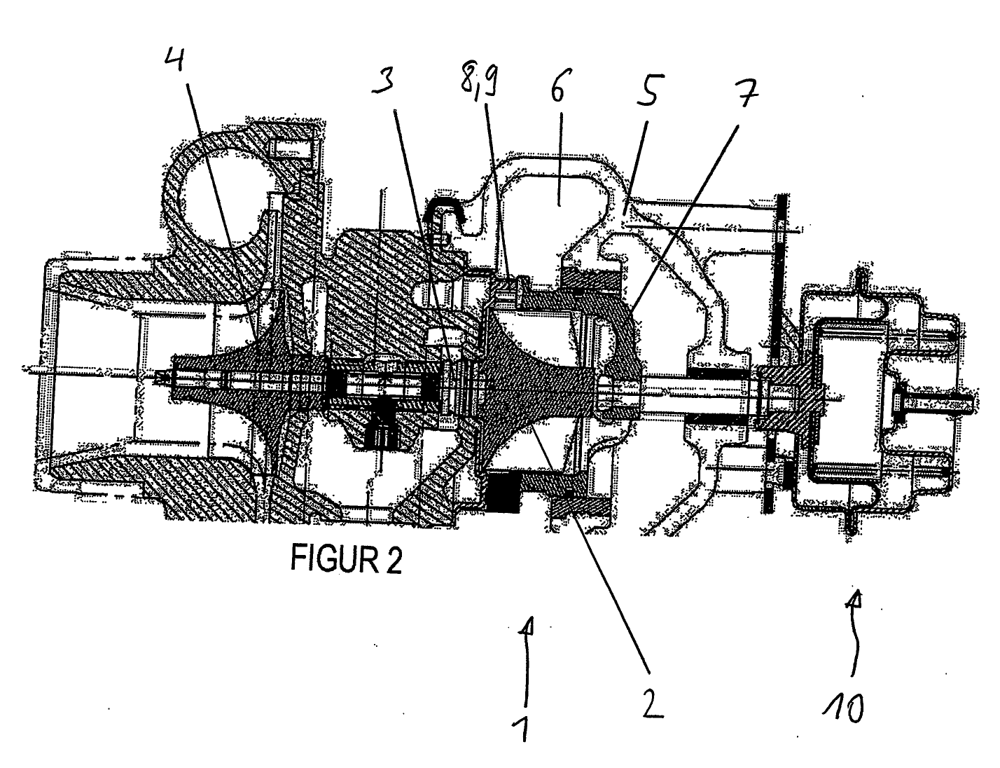

FIG. 2 shows another view of the turbine at low rotational speed according to the first embodiment; and

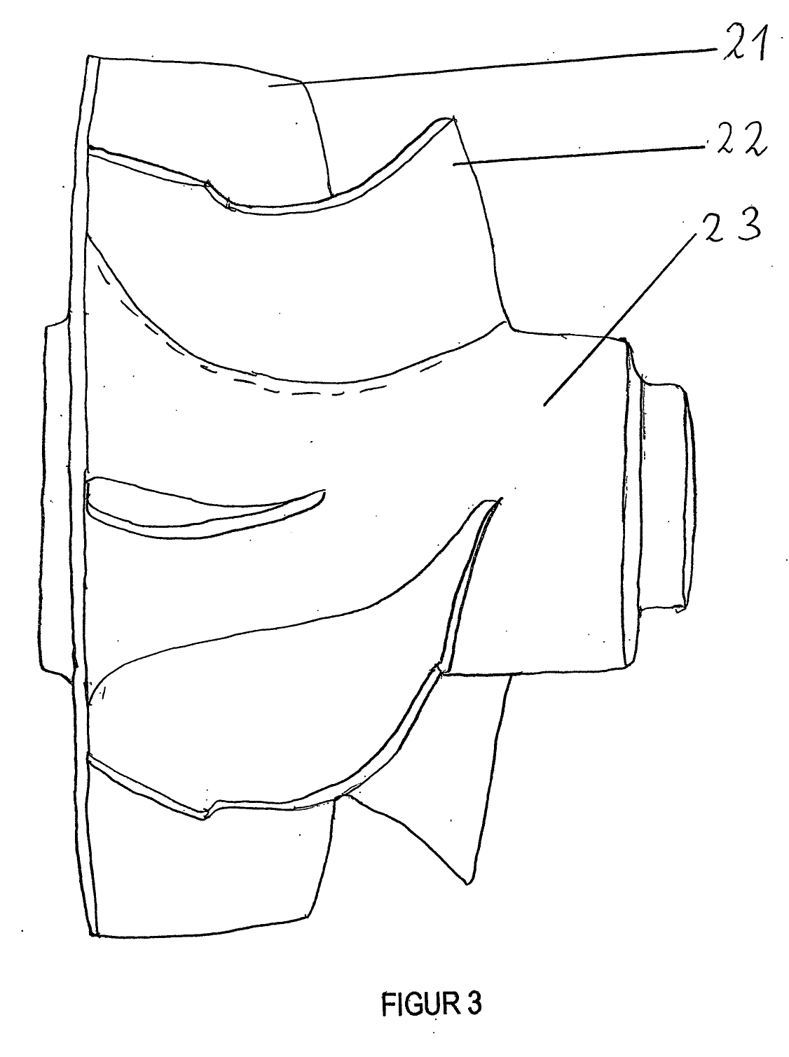

FIG. 3 shows a turbine wheel of a turbocharger according to a second embodiment of the present invention.

A first embodiment of a turbine according to the present invention is described with reference to FIG. 1 and FIG. 2.

A turbine 1 according to the present invention is usually to be incorporated in a turbocharger for a vehicle engine, and the turbine 1 is driven by an exhaust gas emitted from the engine (not shown). Such a turbine 1 is constituted by a turbine wheel 2 mounted at one end of a rotatable shaft 3, while a compressor impeller 4 is mounted at the other end of the rotatable shaft 3. The turbine wheel 2 is accommodated in a turbine housing 5 which forms a passage 6 or a volute for guiding an exhaust gas flow from the engine to the turbine wheel 2.

Within the passage 6, a variable throat provides a smallest cross section of the fluid flow, i.e. a so-called throat area 8. In other words, the variable throat provides a variable “bottleneck” for limiting a maximum exhaust gas flow to pass, from the volute to the turbine wheel 2. In this way, the throat area 8 provides a maximum exhaust gas flow which matches to an operational state of the turbine.

In this embodiment, the variable throat of the turbine according to the invention is always defined by an annular member 7 or a hollow shaft (a hollow piston) surrounding the turbine wheel 2, the annular member 7 being movable in the axial direction of the turbine wheel 2.

Further, in face of the annular member 7, an tubular nozzle is arranged. The nozzle is constituted by an tubular arrangement of vanes 9 for defining a plurality of nozzle passages. In this embodiment, the vanes 9 are stationary, but it is also possible to adopt movable vanes.

The movement of the annular member 7 in the axial direction of the turbine wheel 2 is effected by an actuator 10 which is, preferably, a pneumatic actuator 10. Thereby, the annular member 7 is moved to or from the vanes 9 of the tubular nozzle.

Preferably, the annular member 7 is operated by means for operating the annular member 7 in such a manner that the annular member 7 is moved away from the vanes 9 as an operational rotational speed of the turbine wheel 2 increases, and that the annular member 7 is moved to the vanes 9 as the operational rotational speed of the turbine wheel 2 decreases.

As it is shown in FIG. 1, in high rotational speed ranges, the annular member 7 is positioned far away from the vanes 9 so as to enlarge the throat area 8. Advantageously, the flow capacity is increased such that an engine backpressure in the high rotational speed range of the turbine 1 is reduced.

As it is shown in FIG. 2, in a low rotational speed range of the turbine wheel 2, the annular member 7 is positioned closer to the vanes 9 so as to reduce the throat area 8. Thereby, the turbine 1 exhibits a improved efficiency even in the low rotational speed range of the turbocharger.

The first embodiment according to the present invention achieves a large boost in the low rotational speed range due to the reduced throat area 8 when the annular member 7 is in a position closest to the vanes 9.

In high rotational speeds of the engine, the backpressure is reduced due to the enlarged throat area 8 when the annular member 7 is positioned far away from the vanes 9.

A turbine wheel 2A of a turbine 1 according to a second embodiment of the present invention is shown in FIG. 3. The remaining parts are the same as in FIGS. 1 and 2.

The turbine wheel 2A comprises a boss 23, a plurality of first blades 21 and a plurality of second blades 22, wherein the first and second blades 21, 22 are both flush at one lateral side of the boss 23 (the left side according to FIG. 3). The first blades 21 each have a length in the axial direction of the boss 23 which is smaller than the length of the second blades 22 in the axial direction of the boss 23. Furthermore, the first blades 21 are alternately arranged with the second blades 22.

Considering the left side of the turbine wheel 2A according to FIG. 3, the turbine wheel 2A comprises twice as much blades as on the right side of the turbine wheel 2A according to FIG. 3.

The left side of the turbine wheel 2A according to FIG. 3 is optimized with respect to the reduced throat area 8 when the annular member 7 is positioned closer to the vanes 9, while the right side of the turbine wheel 2A according to FIG. 3 is optimized with respect to the enlarged throat area 8 when the annular member 7 is positioned far away from the vanes 9.

This arrangement of the turbine wheel 2A promotes the advantageous effects of the turbine 1 as they are mentioned above.

The embodiments described herein are to be considered as illustrative and they do not limit the scope of protection. The invention can be modified within the scope of the attached claims.

1. Turbine (1) for a turbocharger, comprising a turbine wheel (2; 2A) and a turbine housing (5) forming a passage (6) for guiding a fluid flow to the turbine wheel (2; 2A), said passage (6) comprising a variable throat providing a throat area (8) as a smallest cross section of the fluid flow,
characterized in that
the variable throat is always defined by a annular member (7) surrounding the turbine wheel (2; 2A) and being movable in the axial direction of the turbine wheel (2; 2A); and
the turbine wheel (2A) comprises turbine blades (21, 22) extending with different lengths in the axial direction of the turbine wheel (2A).

2. Turbine (1) for a turbocharger according to claim 1, wherein the turbine wheel (2A) comprises a plurality of first turbine blades (21) each having a first length corresponding to a first throat area, and a plurality of second turbine blades (22) each having a second length corresponding to a second throat area, wherein the first length being different from the second length.

3. Turbine (1) for a turbocharger according to claim 2, wherein the first and second turbine blades (21, 22) are alternately arranged in the circumferential direction of the turbine wheel (2; 2A).

4. Turbine (1) for a turbocharger according to any one of claims 1 to 3, further comprising a nozzle disposed within the passage (6).

5. Turbine (1) for a turbocharger according to any one of claims 1 to 4, wherein the annular member (7) is moved in accordance with an operational state of the turbocharger.

6. Turbine (1) for a turbocharger according to claim 5, wherein the throat area (8) increases if a rotational speed of the turbocharger increases.
